(19) United States
(12) Patent Application Publication
(10) Pub. No.: US 2020/0013263 A1
(43) Pub. Date: Jan. 9, 2020

(54) AUTONOMOUS AIRCRAFT LOCATOR SYSTEM

(71) Applicant: OKSOS LOCATOR SOLUTIONS INC., Kelwna (CA)

(72) Inventor: James Gordon LEE, Kelowna (CA)

(21) Appl. No.: 16/486,776

(22) PCT Filed: Mar. 29, 2018
(86) PCT No.: PCT/CA2018/050392

§ 371 Date: Aug. 16, 2019

Related U.S. Application Data
(60) Provisional application No. 62/479,031, filed on Mar. 30, 2017.

(51) Int. Cl. G08B 5/00; B63B 22/12; B63C 7/26; B64D 25/20; B64D 45/00; H02J 7/00

(52) U.S. Cl. CPC G08B 5/002; B63B 22/12; B63C 7/26; B64D 2045/0065; B64D 45/00; H02J 7/0042; B64D 25/20

(57) ABSTRACT

Embodiments of emergency locating devices are described. In one embodiment, an emergency device includes a fixed part and a breakaway part, with the fixed part sized and shaped to receive the breakaway part, and wherein the breakaway part is buoyant in water and includes a signaling device that can transmit a distress signal.

### FIELD

This disclosure is generally directed to devices and methods for life-saving in emergency situations, such as life-saving or vehicle (e.g., aircraft) location in water or wilderness.

### BACKGROUND

Currently used methods for locating and signaling, missing, lost and otherwise unknown locations of people, planes, boats and anything else which could be deemed needing recovery, are primarily dependent on electronic signaling devices which communicate with the COPAS-SARSAT (“CS”) satellite system for reporting them being lost and giving their locations. While this is a very useful and effective method, it does have some drawbacks which in some instances can be overcome. The major failing of electronic systems relying on CS is they need an electronic device to receive and relay a message. While the electronic signals are sent and received quickly, there can be lengthy delays between the time the electronic message is sent and when the message reaches somebody who can do something about it. In Search and Rescue time is life. In many situations there may be people in the vicinity who can see the person who is in distress but who are out of hearing range because of distance or ambient noise, and are not connected to CS or 911 systems, so are not aware of the problem.

The solution to the issue of letting people in the vicinity know there is a problem is a visual signal. Visual signals have the advantage of being instantaneous and in many situations the person receiving the signal may well be in a position to render assistance, thereby potentially reducing the response time dramatically, a. The visual signal could for example be triggered by the victim elevating a balloon filled with a lighter than air gas and having markings indicating assistance required, such as SOS. The balloon would also assist rescuers who have been alerted to the problem electronically, for example by CS, as the balloon would be in the air above the person needing assistance.

An example of an application for a balloon of this nature would be a boat in distress. Normally if the boat had a radio they would send out a distress signal and then shoot off a flare to attract attention. A balloon may be launched when the flare is launched. The balloon remains airborne so as the flare attracts attention the balloon marks the location. The balloon may stay in the air for several days ensuring that anybody seeing it will know there is a problem and a response required. Recreational boaters, especially smaller boats who may not have radios or flares, are a group who could use of this type of balloon. Often in recreational boating areas such as in lakes or coastal waters there may be many boats in the vicinity, so by putting up an SOS balloon every boater in sight knows the boat putting up the balloon has a problem.

There are a number of patents, for example U.S. Pat. Nos. 7,886,682, 4,872,414, 5,005,513, 5,582,127, and 6,359,568, that show or describe elevating a balloon into the air which is attached to a victim by a tether so that the balloon can be seen by would be rescuers. All have different methods of achieving the objective, and all have their drawbacks.

In the example of an aircraft, another failing of electronic signaling is that when an airplane crashes in water it sinks. In this situation even though the Emergency Locator Transmitter (“ELT”) devices using CS may be triggered, the transmitted radio waves are attenuated by the water and do not communicate with the CS system, so the airplane is essentially lost. Recent high-profile examples of airplanes being lost in water are Malaysian flight MH370, and Egypt Air flight 804. In both cases searches were initiated but their locations were unknown. In the case of flight MH370 the aircraft has never been found, and after 2½ years and 200 million dollars in search costs, the search has been terminated. In the case of flight 804 the plane was located after several weeks of searching and eventually the black boxes with the flight recorder data were recovered. The issue here is that because the ELTs were on the crashed airplane and therefore underwater they did not transmit a signal that could be picked up the CS system. The solution is to provide an ELT that detaches from the plane when it crashes into water, and which floats on the water and transmits its signal from the water surface to the CS system. The crash would then be quickly reported, and its location identified allowing rescuers to go directly to the crash site. This becomes extremely important if there are survivors, as once again time is life. A device of this nature may be small in size, light in weight and relatively inexpensive.

Another advantage of the exterior mounted ELT is, when a plane crashes on land, the coax cable between the in plane mounted ELT and the exterior mounted antenna can be damaged in the crash causing the signal to be disabled. The interior mounted ELT could also be destroyed by fire as a result of the crash, again disabling the signal.

U.S. Pat. No. 8,687,375 and US Published Patent Application US 2016/075,445 disclose exterior mounted ELT's, but involve very complex mounting systems having many moving parts.

### SUMMARY

In embodiments of the present disclosure, an emergency locator device is provided, comprising a case containing, a tether, an elevation means, and an elevatable beacon. In some embodiments, the tether may be attached directly to the object or person desired to be located. In other situations the tether maybe attached to a weighted means such as a grappling hook. In some aspects of the present disclosure, the elevatable beacon may include a lightweight inflatable device, such as an inflatable beacon, and the elevation means may include a gas source which provides gas to inflate the beacon. Optionally, some embodiments may include an emergency locator transmitter, or other similar device which emits a signal that may be received by a searcher seeking to locate the person or object. In some embodiments, the emergency locator transmitter or similar device may be attached to the weighted means, and in other embodiments, the emergency locator transmitter may be coupled to the tether. For purposes of explanation, the opposing end of the tether may by attached to an aircraft; the concepts and apparatus described here may be applicable to things other than or in addition to aircraft, such as ships, boats, life rafts, or persons.

In other aspects of the present disclosure, a lighter-than-water or lighter-than-air gas is stored in a gas source, such as a gas canister, for inflating the elevatable beacon when the emergency location device needs to be deployed from a submerged position or crash site or other distress location. In some aspects of the present invention, the elevatable beacon may further feature markings on the external surface of the beacon, such as for example the letters “SOS” which is a well-recognized distress symbol. In other aspects, the elevatable beacon may include an illumination means, such as for example a light source coupled to or located within the beacon, and/or markings that are visible in the dark or low-light conditions.

In another application the signaling device can be designed as its own entity and attached to an airplane in such a way that in the event of a crash into water it will separate from the airplane and float on the water and send a signal to the COPAS-SARSAT system which would immediately signal that the plane had crashed. It may for example give its GPS coordinates, so that search and rescue could be sent directly to the crash site greatly increasing the possibility of rescuing any survivors who had survived the crash.

In one embodiment, not intended to be limiting, the break-away floatation may be held into a base which is mounted to the aircraft, wherein the break-away part (which will be referred to as the “foot”) is held magnetically to the base (which will be referred to as the “shoe”) by both an electromagnet and a permanent magnet. The electromagnet is powered by the aircraft electrical system, and is sufficiently powerful to attach a ferrous metal component of the break-away part to the base so that the break-away part will not come off during flight. Upon a crash, at some point at the time of the crash or shortly thereafter as the aircraft sinks, the electrical system will fail thereby de-energizing the electromagnet. The break-away part is then merely held in place by the much weaker permanent magnet. If the break-away part has not already disengaged from the base because of the g-forces on landing, the flotation component, such as styrofoam or other lighter than water material, has a buoyancy which, once submerged, overcomes the force of the permanent magnet, thereby de-coupling the break-away part from the base, and triggering the distress signal from the, then floating on the surface, break-away part. The base may be mounted in a lower-drag location on the aircraft, for example under the tail at the after-most end of the aircraft.

### BRIEF DESCRIPTION OF THE DRAWINGS

FIG. 1A is a top elevation view of the casing of an embodiment of the emergency locator device.

FIG. 1B is a side elevation view of the casing shown in FIG. 1A.

FIG. 2 is a top elevation cutaway view of the device shown in FIG. 1A.

FIG. 3 is a schematic view of the device shown in FIG. 2, wherein the device has deployed on land and the tether is tied to weighting means, in this case a grappling hook which keeps the balloon from drifting.

FIG. 4 is a schematic view of an embodiment of the present disclosure wherein the device coupled to an airplane has deployed under water.

FIG. 4A is the spooling device which is the part of the device shown in FIG. 4, and is the device that spools out the tether that is attached to the sunken airplane. The spooling device in turn is attached to the balloon which remains at the surface of the water and is the platform for the signaling device

FIG. 5 is a side view of the disclosed device which is, upon the aircraft crashing into the water, designed to break off the airplane, float on the water and send an electronic signal to the COPAS-SARSAT system.

FIG. 6 is a side view of the ballasted keel version of the disclosed device.

### DETAILED DESCRIPTION

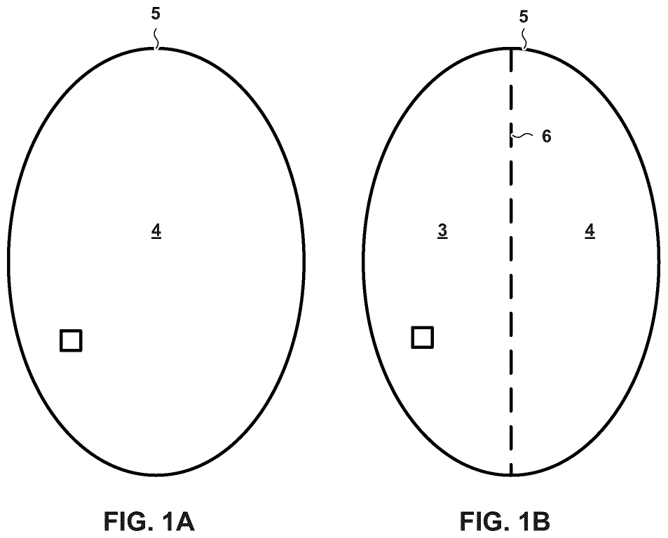

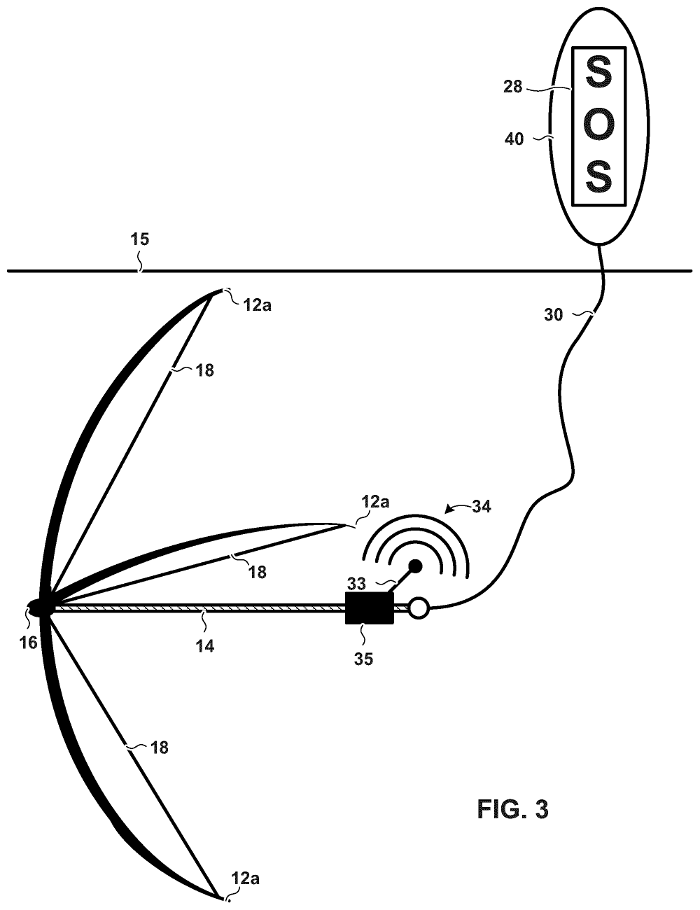

Referring to FIGS. 1 through 6, it will be understood to a person skilled in the art that the elements of the device 1 as illustrated in FIGS. 1 through 6 are not necessarily drawn to scale with respect to the other elements of the device or elements representing the surrounding environment in which the device is deployed. For example, FIG. 3 illustrates a weighting means comprising a grappling hook which appears to be approximately the same dimensions as an elevatable beacon 40. However, the elevatable beacon 40 maybe, for example, much larger than the weighting means 10. The Figures are meant for illustration purposes only and are not intended to limit any of the elements of the device 12 a particular size or shape.

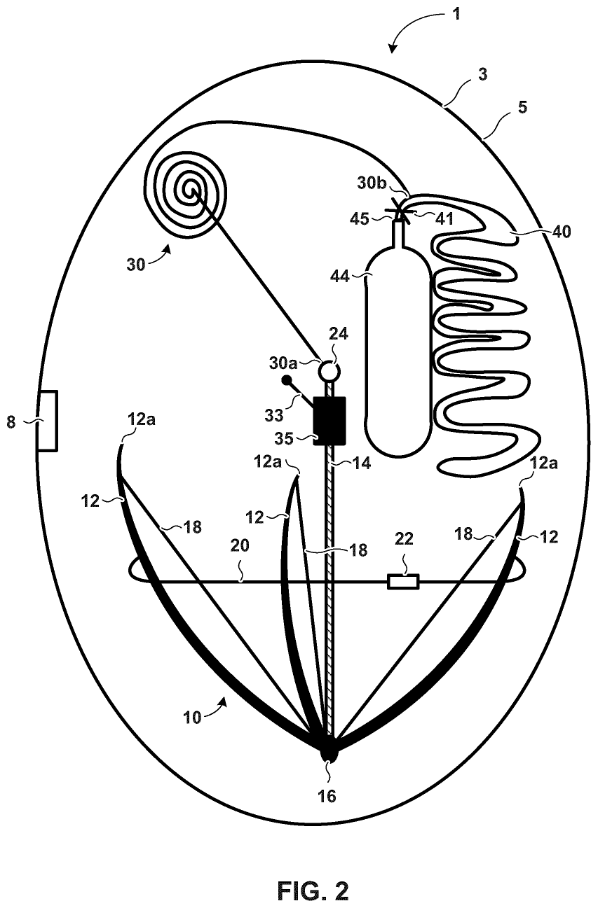

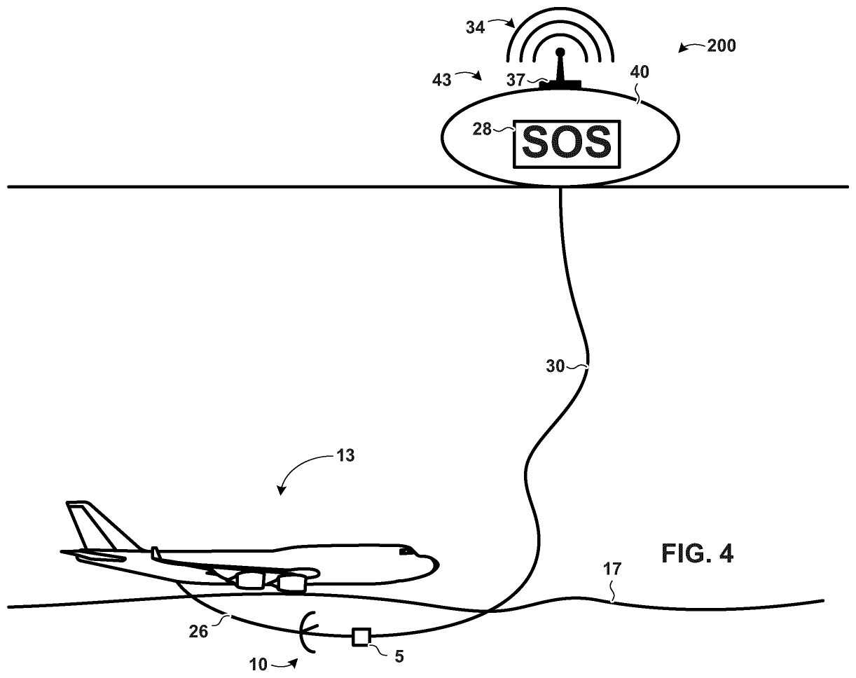

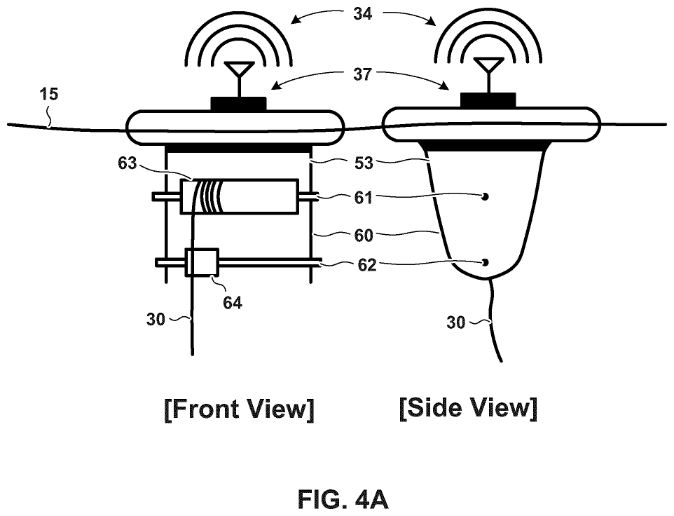

Furthermore with respect to FIG. 4 in particular, the surface 15 may be generally described as an element of the surrounding environment in which the device 200 is deployed, specifically an interface between a substance and the atmosphere, such as for an example the surface of the ocean; the ocean floor 17 illustrated in FIG. 4 is again intended to provide some environmental context in which the device 200 may be deployed, and is in no way intended to limit the deployment of the device 200 in the context of an object 13 submerged in an ocean. Device 200 may contain the components shown in FIG. 4. Device 1 in FIG. 2 is representative of how a device designed to operate with an airplane that has crashed on land would be packaged. The post-crash view of the device 1 in its signaling mode is shown in FIG. 3. The packaging of the components of device 200 which is shown in signaling mode in FIG. 4, of an airplane that has crashed in water would be very different, as while the operational principles are the same, the components and operation are quite different.

The structure of the device 1 will now be more specifically described, with reference to FIGS. 1 through 3. FIG. 1A illustrates the top portion 4 of the clamshell casing 5 for an emergency locator device, while FIG. 1B illustrates a side surface of the casing 5, showing the bottom portion 3 and the top portion 4 of the casing 5 coupled together by a hinge 6, enabling the casing 5 to open in a clamshell manner. As best seen in FIG. 2, which shows the bottom portion 3 of the casing 5, with the top portion 4 removed, the bottom portion 3 and top portion or of the casing 5 are held together by a releasable fastener 8.

Inside the emergency locator device 1 there is included a weighting means 10, which for example in the illustrated embodiment, may be a grappling hook comprising a plurality of claws 12 coupled to a shaft 14 by one or more hinges 16, and a leaf or other type of spring 18 extending between each of the claws 12 and the shaft 14 or the hinge 16. In general, the weighting means 10 comprises any object that would resists lifting under ordinary conditions by gravity; it may be a functional element (such as a grappling hook or other anchoring apparatus) or it may be dead weight, or any combination of functional and non-functional elements. A selectively releasable band 20 encircles the plurality of claws 12 and the shaft 14, ideally maintaining the plurality of claws 12 and the plurality of leaf springs 18 in a position such that there is tension in the springs 18. The selectively releasable band 20 is coupled to an electromagnetic relay 22, which relay 22 maybe triggered at an appropriate time so as to release the band 20, thereby allowing the tension in the springs 18 to extend the distal ends 12a of the plurality of claws in a radially outward direction from shaft 14, as may be better seen for an example FIG. 3.

The weighting means 10, such as the grappling hook shown in the embodiments illustrated in FIGS. 2 and 3, may further comprise a coupling 24, such as an eyelet, mounted to or formed integrally with the shaft 14. The coupling 24 may be utilized for coupling a first end 30a of the tether 30 to the shaft 14. The tether 30 may be stored within the casing 5 for example as a coil wrapped around a spool (as indicated by FIG. 2), or any other suitable means for storing a relatively long length of tether 30 within the casing 5. A second end 30b of the tether 30 maybe coupled to an elevatable beacon 40, such as for an example a deflated beacon as illustrated in FIGS. 2, 3 and 4. Also positioned within the casing 5 maybe elevating means for elevating the beacon, such as for example a gas canister 44 containing a compressed gas that is preferably less dense than water, atmosphere, or any other such substance in which a person or object may become submerged.

In different embodiments of the present disclosure, the compressed gas contained in canister 44 would be selected to suit the intended need of the medium in which it is expected to function. For example, a balloon needed to rise into the atmosphere, a lighter than air gas such as helium could be selected; for a balloon needing to reach the water surface 15, a less expensive inert gas (for example) could be selected, as it is not necessary to elevate the beacon 40 above the surface 15 into the atmosphere; merely positioning the beacon on the surface 15 will enable the beacon to be visually detected. Other gases may also be used which are suitable to elevate a beacon 40 in a given substance and come within the scope of the present invention.

In FIGS. 1 to 3, the gas canister 44 includes an opening 45, to which an opening 42 of the elevatable beacon 40 maybe mounted, so as to cause the elevatable beacon 40 to be in fluid communication with the gas canister 44 when the gas canister 44 is opened by opening means 41, such as for example a valve, or a needle, spike or other structure comprising a sharp end so as to puncture a seal that may be sealing the opening 45 of canister 44.

In some embodiments of the emergency locator device 1, there may be mounted to the weighting means 10 a housing 35, which contains, for example, one or more timers and one or more actuators for deploying the emergency locator device 1 in a plurality of timed stages, as will be further described below. There may optionally be a secondary tether 26 connecting the weighing means 10 to the aircraft 13 (as shown in FIG. 4), or the weighting means 10 may physically separate fully from the aircraft 13. Optionally, the housing 35 may also include an emergency locator transmitter 37 (not shown in FIG. 1) and an antenna 33 for transmitting a signal 34 from the emergency locator transmitter 37. In general, emergency locator transmitter 37 is at least one kind of signaling device, and it may be capable of communication with the CS system. The emergency locator transmitter 37 may include other kinds of signaling capability as well, including other kinds of radio transmission, optical signaling (e.g., strobes), visible signaling other than by light emission (e.g., coloration or release of dye marker), or audible locators. The emergency locator transmitter 37 may include apparatus to ascertain the GPS co-ordinates of the emergency locator transmitter 37.

Providing an emergency locator transmitter 37 mounted to the weighting device 10, provides an emergency locator transmitter 37 which, when the device 1 has been deployed, may position the emergency locator transmitter 37 proximate to, rather than adjacent to or contained within, an object desired to be located, such as an aircraft which has crashed on land and which may potentially be on fire, which may advantageously protect the emergency locator transmitter from damage that would otherwise have been caused by the fire impacting the aircraft.

Example of stages of deployment of device 1 an airplane crashes on land, deploying equipment contained in housing 35, attached to shaft 14.

### Aircraft Crash Example—Crash on Land

When an aircraft hits the ground an impact sensor immediately activates the release of a capsule similar to that shown in FIG. 2, and triggers the first time delay (TD1) which delays release of a locator balloon.

The impact sensor for example similar to those used in automobile airbags immediately activates the capsule release mechanism and the capsule is released from the airplane. The time delay TD1 is set to allow enough time for the capsule to settle on the ground, and any potential fire to die down. The balloon is released from the capsule after TD1. This avoids the balloon catching fire if it is too close to the plane. The time delay TD1 may be up to an hour.

When TD1 expires or times out the capsule is allowed to open. This triggers the second time delay TD2.

The second time delay TD2, allows enough time for the capsule to fully open, before the balloon is triggered, s so as to avoid the balloon getting snagged in the capsule's opening apparatus.

When TD2 times out the balloon mechanism is activated and a third time delay is TD3 is triggered, after which an ELT is activated. The third time delay TD3 allows enough time for the balloon to inflate and clear the area before it triggers the ELT.

When TD3 times out the ELT is triggered and activated. Note, TD3 may not be necessary if the ELT remains on the ground, for example strapped to the shaft of the grappling hook. The purpose of the grappling hook is to catch on to a snag on the ground in the event the balloon is dragged by a wind, as well as ensure that the weight on the ground exceeds that of the lift providing ballast to the balloon.

### Aircraft Crash Example—Crash on Water

Example of stages of deployment of device 200 when an airplane crashes into water, deploying equipment contained in housing 200.

1. Aircraft hits water and detaches from airplane upon impact with water triggers TD1 (water trigger).

1st time delay is to allow enough time for the plane to settle, in the event that it is triggered while the plane is still in crashing mode.

2. 1st TD times out and triggers mechanism that will release capsule containing all that's intended to remain on the surface, and triggers TD2.

The capsule remains tethered to aircraft via tether 51, which I envision to be about the same length and the plane and strong enough to resist any cutting or abrasion if it were to get caught up in the wreckage of the sinking plane. The capsule itself should be designed to float, this could be achieved by using styrofoam packing which would keep the components safe from damage from vibration prior to use. The reason for the floating capsule is once it is released from the plane you want it to float away and be independent from the wreckage, prior to opening up.

3. 2nd TD times out allowing the capsule to open and triggers TD3.

The purpose of TD3 is to allow the capsule to fully open and the styrofoam to float away, this would be a relatively short period of time say 30 seconds, as the rest of the capsule would begin to sink right away, so it is important that the balloon begin to inflate as soon as possible.

4. 3rd TD times out and triggers the cylinder to fill the balloon which is the beacon, and triggers TD4.

The beacon/balloon in this case is of a substantial enough size and a material that is strong enough to support the spool, the tether 30 is wound on. The tether needs to be strong enough to keep the balloon attached to the plane, given that it could be several kilometers long, that might seem substantial but in fact there will be less strain on the tether than one might expect. The main stress point would be where the tether attaches to the balloon or where it meets the spool 53, the primary stresses come from wave action and wind, so the balloon would want to be low in profile so as to reduce wind exposure and large in diameter to make it more visible from the air. The long tether will have a huge sag in it, the longer the tether the bigger the sag, the sag will act as a shock absorber reducing and almost eliminating any jerking type of stress at the point where the tether attaches to the spool 53. The spool 53 itself would have a light spring like tension on it so as the plane sank there would be a light tension on the tether, once the plane came to rest the spring would keep the beacon from drifting too far as wave action would continue to pull the tether out so it needs to rewind the slack.

5. 4th TD times out and activates ELT.

TD 4 needs to allow enough time for the balloon/beacon to fully inflate, and settle, a couple of minutes would suffice, and then the ELT is activated. This is the most important function of this device because it immediately alerts search and rescue as to the precise coordinates where the plane went into the water, and rescuers can be dispatched directly to the location. The importance of this would be dramatically enhanced if there were survivors.

Within the enclosure 200 which contains the components shown in FIG. 4 there is a spooling device 53 shown in front cutaway view and side view in FIG. 4A and described here.

### Description of Spooling Device 53 Attached to Balloon 40

The tether 30 between the sunken plane 13 and the balloon 40 which is floating on the surface of the water 15, is attached to a spooling device 53. The spooling device consists of a frame 60 which is attached to the balloon 40. Balloon 40 is designed to lie like a blob on the water 15 so that there is minimal resistance to wind, but has enough flotation to support the spooling device 53 and its components. The frame 60 supports two spindles 61 (upper spindle) and 62 (lower spindle). Spindle 61 supports a drum 63 on which the tether 30 is wound. Spindle 62 supports a guide 64 which contains a tension device (not shown), the purpose of which is to ensure that the drift of the balloon due to wind and wave action is minimal. Jerking action on the tether 30 due to wave or wind action is not expected as the balloon would not be directly above the plane (unless it was fully extended) creating a sag in the tether 30, which would act as a shock absorber.

### A Signaling Device Alternative

### Break off Floating Locator

A problem in the air flight industry, concerning both large and small aircraft, is that when a plane crashes on water and sinks their ELT devices don't work because radio waves don't travel through water like they do through air, and therefore once the plane sinks there is no locator signal being transmitted. This concern is not necessarily restricted to the air flight industry, but for purposes of illustration, the concept will be described in this context.

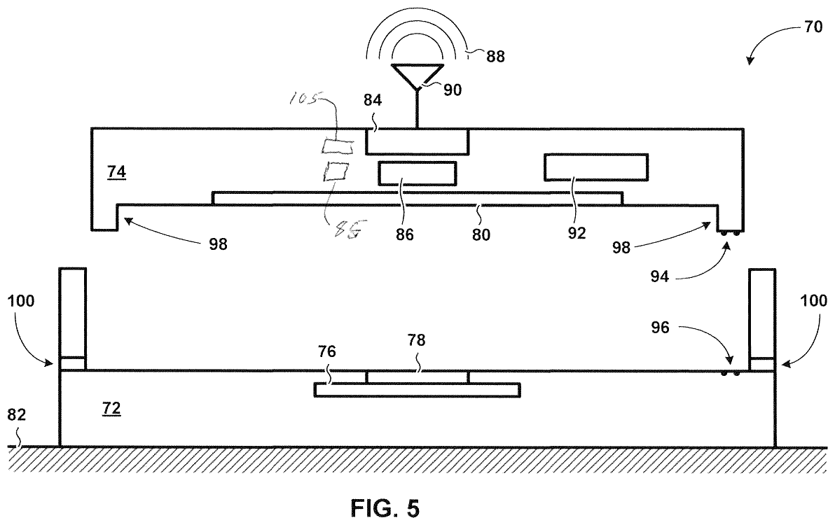

One solution is to have the ELT in a floating locator which is mounted on the aircraft break free upon impact. An illustration of such a locator assembly 70 appears in FIG. 5. The break-off floating locator, in a typical embodiment, is designed to separate from the airplane upon impact with the water, and float on the surface of the water and send a signal to the CS system giving the airplane's identification and GPS coordinates. The airplane's position may thus become known to search and rescue quickly after the crash.

The locator assembly 70 has two parts: although they may be called generally a detachable or breakaway part and a fixed part, they will be called here for convenience a “shoe” 72 and a “foot” 74. The “shoe” 72 is sized and shaped to receive the “foot” 74. As with a conventional shoe and foot, the “foot” 74 may be held securely by or within the “shoe” 72, but the “foot” 74 can also be removed from the “shoe” 72. The “shoe” 72 may be shaped, as illustrated by FIG. 5, as a receptacle sized and shaped to receive the “foot” 74. The “shoe” 72 is, in a typical embodiment, very securely or permanently fastened to the plane 82, such that the “shoe” 72 is not dislodged from the aircraft 82 by wind, pressure, turbulence, impact, or other disturbance. The “shoe” 72 may include one of more fastener structures (such as clamps, screw holes, braces, hooks, wires, latches, pins) that aid in securing the “shoe” 72 to the aircraft 82. In the embodiment shown in FIG. 5, the “foot” 74 snugly fits into (is received by) the “shoe” 72. As will be described, the “foot” 74 will remain physically in contact with the “shoe” 72 under most foreseeable conditions, and will not separate from the “shoe” 72 due to ordinary aircraft operating conditions such as pressure changes or turbulence. Under specific conditions, however, the “foot” 74 separates from and operates apart from the “shoe” 72.

Under ordinary operating conditions, the “foot” 74 remains physically in contact with the “shoe” 72 due to a combination of forces, including physical friction or bearing between the “shoe” 72 and the “foot” 74, and gravity. Further, the locator assembly 70 is depicted as including further apparatus to maintain physical contact between the “shoe” 72 and the “foot” 74 under ordinary operating conditions. In FIG. 5, the “shoe” 72 includes an electromagnet 76 and a permanent magnet 78. The “foot” 74 includes an element of ferromagnetic material 80 that is generally attracted to the permanent magnet 78 constantly, and attracted to the electromagnet 76 when the electromagnet 76 is activated. In a variation, the ferromagnetic material 80 is itself magnetized with poles arranged to attract the permanent magnet 78, but that may be attracted or repelled by the electromagnet 76 depending upon the polarity of the electromagnet 76. Although depicted as a plate in FIG. 5, the element of ferromagnetic material 80 may have any shape. Electric power for the electromagnet 76 may come from the electrical power supply of the aircraft 82. In general, the electromagnet 78 of the “shoe” 72 and the ferromagnetic material 80 of the “foot” 74 are disposed so as to be in proximity to one another when the “foot” 74 is received in the “shoe” 72, such that activation of the electromagnet 76 causes significant attraction of the ferromagnetic material 80. For example, if the electromagnet 76 is disposed in the approximate center of the “shoe” 72, as is indicated by FIG. 5, the element of ferromagnetic material 80 may be disposed in the approximate center of the “foot” 74. Similarly, the permanent magnet 78 of the “shoe” may be disposed to attract the element of ferromagnetic material 80 when the “foot” 74 is received in the “shoe” 72. During ordinary operating conditions of flight, the electromagnet 76 is activated, thereby supplying force to hold the “foot” 74 securely in the “shoe” 72. In this way, the electromagnet 76 aids in fastening the “foot” 74 of the locator assembly 70 to the “shoe” 72, and thereby to the plane 82, when the plane 82 is in operation and an electric current is available. When the plane 82 is not running and not generating an electric current, the “foot” 74 may be held in place in the “shoe” 72 by the permanent magnet 78, which may have a magnetic force less than that of the electromagnet 76. The “foot” 74 includes a signaling device 84 and a battery 86, such as described above. The battery 86 supplies power to the signaling device 84 to emit a signal 88, such as a transmitted distress signal. The signal may be, for example, a radio signal emitted by an antenna 90 capable of communication with the CS system. The signal may also be a radio frequency signal that is capable of communication with another type of radio-based system, or a visible light signal emitted by a light or strobe (not shown), or a sound signal emitted by a sound generating device (not shown), physical signaling system such as a dye marker (not shown), or a combination of these. The “foot” may include a charger 92 that is electrically coupled to and configured to charge the battery 86. Additionally, there may be a switch 85 (see FIG. 5) disposed between the ELT signalling device 84 and the power supply 86 so that they may be disconnected. In addition, a monitoring device in the form of a transmitter 105 (see FIG. 5) may be disposed between the switch 85 and the signalling device 84. The transmitter is operable to send a signal to a receiver 105 (not shown) located in the cockpit dash of the aircraft 82 to alert a pilot as to whether or not the ELT is in functioning mode. The transmitter is powered by power supply 84

Power may be supplied to the charger 92 from the electrical system of the aircraft 82, by way of mating electrical contacts 94 and 96. The contacts 94 and 96 mate (thereby establishing electrical contact and a circuit) when the “foot” 74 is received in the “shoe” 72. The charger 92 may derive electrical power from other sources as well, such as solar cells (not shown). The “foot” 74 may also include one or more sensors (not shown, such as magnetic or Hall effect sensors, that respond to the strength of a magnetic field, such that separation of the “foot” 74 from the ‘shoe” 72 results in a detected reduction or absence of the magnetic force of the permanent magnet 78 or the electromagnet 76. Such detection may be used to trigger the signaling device 84 which sends the signal 88. In other words, the signaling device 84 may be configured to transmit the distress signal 88 in response to detection of the separation of the “foot” 74 from the “shoe” 72.

The device is designed so that in a crash situation the g-force upon impact should (in many cases) be enough to cause the “foot” 74 to separate from the “shoe” 72 and therefore from the airplane 82. The degree of impact that would cause separation may be the same from one locator assembly 70 to another; or different assemblies may respond to different degrees of impact. In the event of a soft landing on water where the impact is insufficient to separate the “foot” 74 from the “shoe” 72, and therefore insufficient to separate the “foot” 74 from the plane 82, the “shoe” 72 may be separated from the “foot” 74 in other ways, such as (but not limited to) a commanded ejection or the buoyancy of the “foot” 74. Though the “foot” may include components that are more dense than water, the “foot” 78 as a whole may be designed so that the flotation buoyancy (or buoyancy force of the water) is greater than the magnetic strength of the permanent magnet 78 with respect to the ferromagnetic material 80, and therefore the “foot” 74 separates from the “shoe” 72 triggering the signaling device 84 to send the signal 88. The “foot” 74, as a whole, has a buoyancy (in terms of density and/or volume) that would make it buoyant in water, that is, it would float in water. Various features from devices already described may be included with locator assembly 70; for example, although no tether or anchor or weighting means are depicted in FIG. 5, some embodiments may include such features.

As shown in FIG. 5, standoffs 98 on the “foot” 74 help create a void when the “foot” 74 is inside the “shoe” 72, allowing for a space for water to flood in through the holes 100 in the “shoe” 72, to facilitate the flooding pressure causing the magnetic force to break. The holes 100 may also equalize pressure between the void and the ambient air when the locator assembly 70 is in flight. Although not shown in FIG. 5, the “foot” 74 may include similar openings or other features that enable flooding or pressure equalization.

The break off floating locator or “foot” 74 may be a molded styrofoam with a carbon fibre covering and may be mounted anywhere on the airplane that is convenient. The affixed “shoe” may be made of similar durable construction, but may be made of more robust materials and need not be buoyant. The device shown in FIG. 5 is for purposes of illustration and is not necessarily to scale. Furthermore, the cross-section shown in FIG. 5 is not intended to convey what the locator assembly 70 may look like in three dimensions. The locator assembly 70 may be any shape, such as boxy, cylindrical, wedge-shaped, pyramid-shaped, dome-shaped or any other shape. In any of these configurations, the “shoe” 72 may be sized and shaped to receive the “foot” 74.

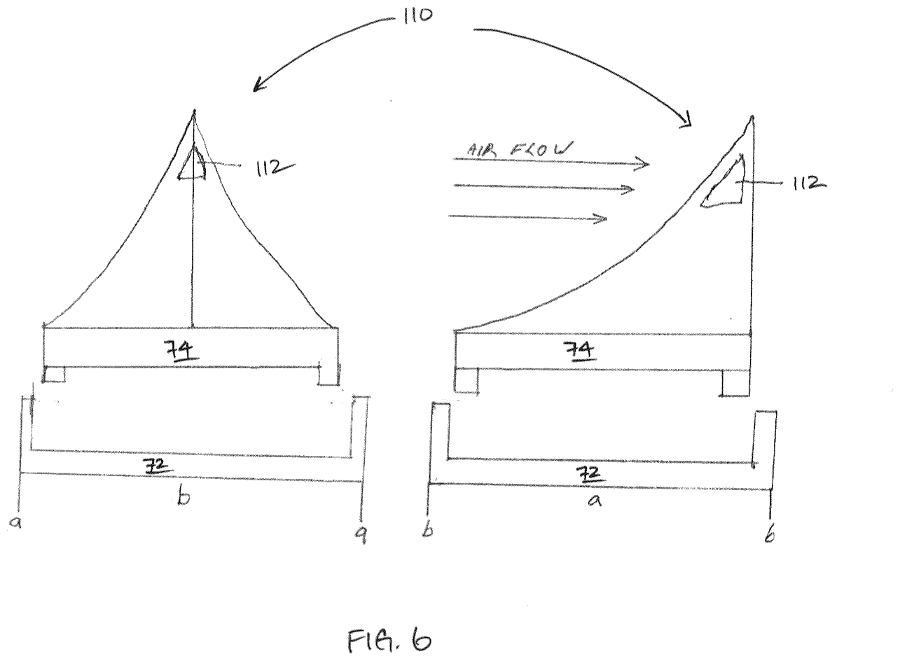

Additionally, foot 74 may include a ballasted keel 110 (see FIG. 6), which comprises a protruding structure and a weight 112, ideally disposed in the keel 110 distally to the base of the foot 74, such that when the foot 74 is disengaged from the shoe 72, the foot 74 remains in a substantially vertical position, as the weight 112 will rotate the foot 74 and stabilize the foot 74 such that the keel 110 leads the foot 74 as it floats, then gradually falls to earth or sinks. Optionally, the keel 110 may include concave or other aerodynamic faces in order to render the foot 74 more stable.

Various embodiments of the locator assembly 70 may realize one or more advantages, some of which have been suggested already. The combination of “shoe” and “foot” may be adapted to virtually any aircraft and may be mounted at any location. Different craft may support different mounting sites, and the locator assembly 70 can be selected or customized for any particular craft or mounting site. The locator assembly 70 may be configured to have the “foot” separate from the “shoe” by command, or to separate automatically with no human intervention (e.g., preventing a malicious actor such as a hijacker from stopping the transmission of an emergency signal), or a combination of both. Further, various embodiments of the concepts described above can be applied to contexts other than conveyance by air (airplane, jet, helicopter, balloon, etc.), such as conveyance by watercraft.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A device comprising:
a fixed part and a breakaway part,
the fixed part sized and shaped to receive the breakaway part and comprising an electromagnet;
the breakaway part being buoyant in water and comprising:
a signaling device;
a power source; and
an element of ferromagnetic material disposed so as to be in proximity to the electromagnet when the breakaway part is received in the fixed part;
wherein the signaling device is configured to transmit a distress signal by radio waves.

2. The device of claim 1, wherein the signaling device is configured to transmit a distress signal to a COPAS-SARSAT (CS) satellite system.

3. The device of claim 1, wherein the fixed part is sized and shaped as a receptacle to receive the breakaway part.

4. The device of claim 1, the fixed part further comprising a permanent magnet disposed so as to be in proximity to the element of ferromagnetic material when the breakaway part is received in the fixed part.

5. The device of claim 1,
wherein the power source is a battery,
the breakaway part further comprising a battery charger electrically coupled to the battery and configured to charge the battery.

6. The device of claim 5, wherein
the fixed part includes a first set of electrical contacts;
the breakaway part includes a second set of electrical contacts that come in electrical contact with the first set of electrical contacts when the breakaway part is received in the fixed part; and
the battery charger receives electrical power from a power source by way of the first and second sets of contacts.

7. The device of claim 1, the breakaway part further comprising a first sensor configured to detect separation of the breakaway part from the fixed part;
wherein the signaling device is configured to transmit the distress signal in response to detection of the separation.

8. The device of claim 1, the breakaway part further comprising a ballasted keel disposed at a lower portion, adapted to maintain the breakaway part in a substantially vertical orientation when disposed in a fluid medium.
